(19) United States
(12) Patent Application Publication
(10) Pub. No.: US 2009/0106308 A1
(43) Pub. Date: Apr. 23, 2009

(54) COMPLEXITY ESTIMATION OF DATA OBJECTS

(76) Inventors: Christopher Killian, Wilmington, DE (US); James Michael Orr, Cincinnati, OH (US)

Correspondence Address: Vedder Price PC, 222 NORTH LASALLE STREET, CHICAGO, IL, 60601, US

(21) Appl. No.: 11/874,542

(22) Filed: Oct. 18, 2007

(51) Int. Cl. G06F 17/30

(52) U.S. Cl. 707/103 Y; 707/E17.055

(57) ABSTRACT

Complexity criteria corresponding to the various data object parameters are received by a processing apparatus via a user interface. Values corresponding to one or more of the data object parameters are determined for a data object and subsequently compared to that portion of the complexity criteria corresponding to the one or more data object parameters. Based on this comparison, at least one complexity parameter rating may be determined for the one or more data object parameters. Based on the one or more complexity parameter ratings, an overall complexity rating for the data object, or an estimated effort for transforming the data object, may be determined. By allowing a user to define the complexity criteria, the subjectivity necessarily present in conventional assessments of data object complexity may be substantially eliminated and analysis throughput substantially increased.

### FIELD OF THE INVENTION

The instant disclosure relates generally to the analysis and transformation of data objects and, in particular, to techniques for estimating the complexity of data objects when undertaking such transformations.

### BACKGROUND OF THE INVENTION

Virtually every day, organizations or entities of every type receive data from external sources and/or generate data internally. As such data is received/generated, it often goes to a so-called “data warehouse” that operates to store such data with varying retention periods of time, levels of security, redundancy, etc. By way of non-limiting example, such data for a company that manufactures and sells “widgets” might include raw sales data for the widgets sold by the company or its distributors, vendor or customer proposals, manufacturing data for the widgets such as production and/or defects rates, the company's financial data, personnel data such as number of employee sick days, the company's entire email system, etc. Not surprisingly, an organization of even relatively modest size may require a relatively large data warehouse to properly store all of its accumulated data. In essence, such data warehouses constitute the institutional “memory” of an organization that may be accessed as desired to gain insight into the operation, culture, performance, etc. of the organization.

A variety of tools, typically implemented using a database management system (DBMS), are currently available to assist organizations in accessing or organizing the stored data, particularly when attempting to develop insights into the various aspects of the organization. For example, Business Objects SA produces various software-based applications that operate in conjunction with the DBMS for this purpose. Using a graphical interface, various ones of Business Objects' applications allow a data analyst to develop so-called “reports” in which various components of the stored data may be organized and presented in a desired format within, for example, a single document. Business Objects also offers authoring applications that allow a data analyst to develop so-called “universes” that describe, typically in a simplified manner, the structure, content, organization, internal relationships, etc. of various databases. Other database interface applications by other providers operate in a similar manner. Collectively, reports and universes are specific examples of data objects used to interact with an organization's data warehouse.

It is not uncommon for an organization to develop hundreds, if not thousands, of data objects as described above. However, such data objects necessarily rely on the architecture of the underlying applications used to create and execute them. If such applications are changed substantially, an organization's investment made in its data objects may be lost, or substantially increased, to the extent that the organization must either abandon or re-author the desired data objects. Referring once again to the Business Object model, such a situation recently occurred when the basic architecture of Business Objects' applications was modified significantly, thereby rendering thousands of data objects obsolete. Rather than re-authoring such data object entirely, it is possible to “migrate” (i.e., transform) pre-existing data objects to be compatible with the revised, underlying applications. Using prior art techniques, such transformations have been time consuming, expensive, and pose various other problems and challenges.

### SUMMARY OF THE INVENTION

The instant disclosure describes various techniques that overcome limitations of prior art techniques through the use of user-provided complexity criteria corresponding to a variety of data object parameters. The data object parameters are features or characteristics that are common to at least some groups of data objects and that may take on various values that may be used to assess the complexity of a given data object. Complexity criteria corresponding to the various data object parameters are received by a processing apparatus via a user interface. Likewise, values corresponding to one or more of the data object parameters are determined and subsequently compared by the processing apparatus to that portion of the complexity criteria corresponding to the one or more data object parameters. Based on this comparison, at least one complexity parameter rating may be determined for the one or more data object parameters. Based on the one or more complexity parameter ratings, an overall complexity rating for the data object may be determined. Likewise, an estimated effort for transforming the data objects based on the one or more complexity parameters may also be determined. In an embodiment, the data objects comprise so-called universes and/or reports developed using various authoring tools provided by Business Objects SA. By allowing a user to define the complexity criteria prior to analysis of the data object, which complexity criteria is preferably defined according to data object parameters that are readily assessed by the processing apparatus, the instant disclosure describes techniques that substantially eliminate the subjectivity necessarily present in conventional assessments of data object complexity and increase analysis throughput rates.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is a schematic block diagram of a system in accordance with an embodiment described herein;

FIG. 2 is schematic block diagram of another system, illustrated in greater detail, in accordance with an embodiment described herein;

FIG. 3 is a schematic block diagram of a processing apparatus in accordance with an embodiment described herein;

FIG. 4 is a flowchart illustrating processing operations in accordance with an embodiment described herein;

FIG. 5 is an illustration of a portion of a user interface that may be used to obtain complexity criteria for a variety of data object parameters in accordance with an embodiment described herein;

FIG. 6 is an illustration of another portion of a user interface in which analysis results for a variety of data objects are provided; and

FIG. 7 is an illustration of another portion of a user interface in which additional analysis results for a variety of data objects is provided.

### DETAILED DESCRIPTION OF THE PRESENT EMBODIMENTS

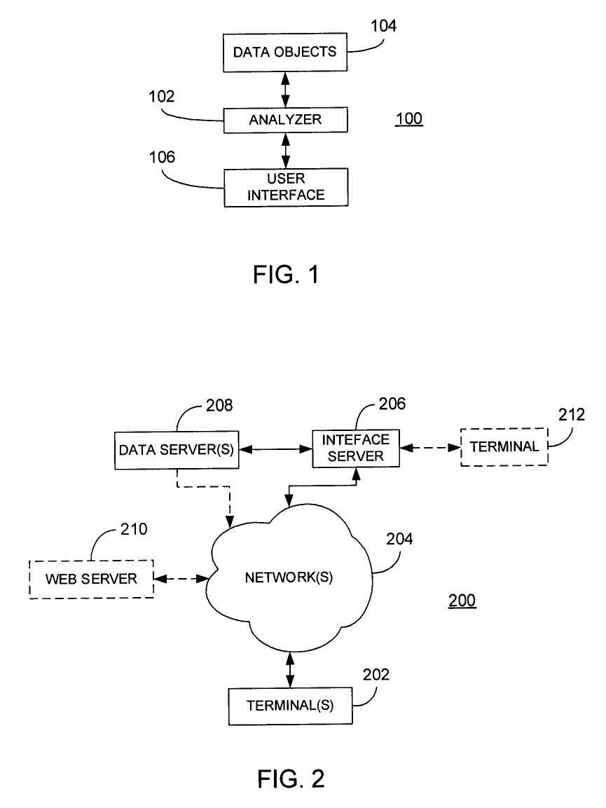

A more detailed description of the various embodiments described herein are provided with further reference to FIGS. 1-7. Referring now to FIG. 1, a system 100 is illustrated comprising a data object complexity analyzer 102 in communication with at least one storage device 104 storing data objects and a user interface 106. The complexity analyzer 102 operates in conjunction with the user interface 106 to obtain various complexity criteria that may be used to analyze data objects stored in the storage device(s) 104. Note that the storage devices 104, which may comprise any type of machine-readable memory or the like, may be local to processing apparatus implementing the complexity analyzer 102 or remote from the complexity analyzer 102, as in the case of a remote server computer or the like. Generally, a data object in accordance with the instant disclosure may comprise virtually any item that may be used to access, manipulate, organize, operate upon or present data stored in a data warehouse including, but not limited to, reports and universes created using Business Objects authoring tools. For example, as known in the art, so-called reports may be developed using Business Objects' Desktop Intelligence application which allows users, among other things, to define a preferred layout of various data stored within the data warehouse 104. In a similar vain, a universe may comprise a metadata (or semantic) layer that may be developed using Business Objects' Universe Designer application to describe the location of one or more databases, the types of data stored within such databases, the internal relationships between data elements within such databases, etc., thereby allowing relevant queries to be established for the databases.

As described in greater detail below, the analyzer 102 is preferably implemented using stored instructions that may be executed by a suitable processing apparatus such as a computer or the like. The user interface 106 preferably comprises a graphical user interface presented to a user of the complexity analyzer 102 via suitable display device. The complexity analyzer 102 obtains complexity criteria for various data object parameters via the user interface 106, thereby precisely defining how complexity ratings may be assigned by the complexity analyzer 102 to the data object parameters corresponding to various data objects stored in the data warehouse 104. With such complexity ratings in hand, overall complexity ratings for each analyzed data object may be determined, as well as estimated efforts required to transform individual or groups of analyzed data objects.

Referring now to FIG. 2, a system 200 in accordance with an embodiment is illustrated. As shown, the system 200 comprises one or more user terminals 202 in communication with a communication network 204 that, in turn, communicates with one or more servers 206-208. As described in greater detail below, each of the terminals 202 may comprise a suitable processing apparatus capable of implementing the processing described below. Additionally, each terminal 202 comprises the necessary hardware and/or software needed to communicate with the network 204 via wired and/or wireless connections. Thus, the terminals 202 may be embodied by desktop/laptop/handheld computers, wireless communication devices, personal digital assistants or any other similar devices having the necessary processing and communication capabilities. In an embodiment, the network 204 may comprise a public communication network such as the Internet or World Wide Web and/or a private communication network such as a local area network (LAN), wide area network (WAN), etc. as known by those having ordinary skill in the art.

The servers 206-208, which may comprise suitable server computers as known in the art, collectively implement the functionality of the at least one storage device 104 illustrated in FIG. 1. For example, an interface server 206 may implement a suitable DBMS that is compatible with Business Objects reports and universes. Such software is provided to serve as an interface to the various data servers 208 that, in turn, implement a data warehouse. As described below, each of the terminals 202 may comprise client software applications that allow the terminals 202 to communicate with the one or more servers 206-208 via the intervening communication networks 204. As known in the art, the data objects operated upon as described herein are preferably stored on either the interface server 206 or, more typically, locally on the terminals 202.

In an alternative embodiment, at least some portion of the functionality described below relative to the terminals 202 may be implemented by one or more web servers 210 connected to the communication network 204. As known in the art, such web servers 210 may provide a suitable interface to the terminal 202 via the communication network 204, while performing the necessary processing needed to implement the complexity analyzer 102 described herein. In this manner, a more centralized implementation is possible. In a further alternative embodiment, another terminal 212, similar in construction and functionality as the network-based terminals 202, may be provided. In this embodiment, the other terminal(s) communicates directly with the interface server 206, bypassing the network 204. Those of ordinary skill in the art will appreciate that the system 200 illustrated in FIG. 2 is a single example of a wide variety of system implementations that may be used in accordance with the instant disclosure, which is not necessarily limited to any single implementation. For example, although the data servers 208 are described above as implementing a data warehouse, they may be equally employed as storage for operational data, i.e., data not yet stored in a data warehouse.

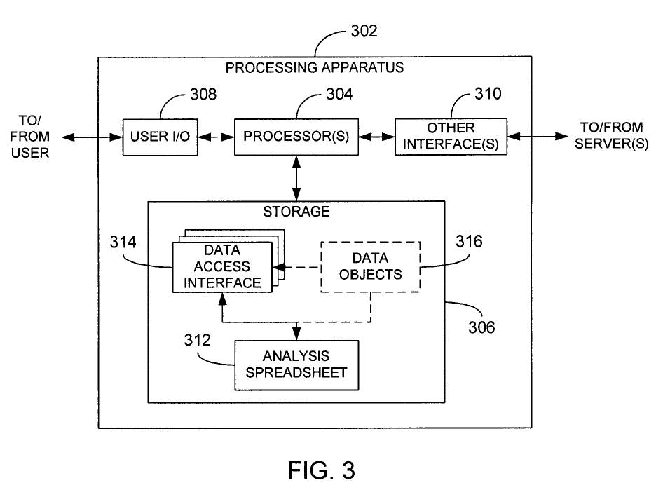

Referring now to FIG. 3, a processing apparatus 302, suitable for implementing the terminals 202, 212 illustrated in FIG. 2, is further illustrated. As shown, the processing apparatus comprises one or more processors 304 in communication with one or more storage devices 306. As known in the art, the processor(s) may comprise a microprocessor, microcontroller, digital signal processor, co-processor or other similar devices known to those having ordinary skill in the art. In a similar vein, the storage devices 306 may comprise in combination of volatile or nonvolatile memory such as random access memory (RAM) or read only memory (ROM). Such storage devices 306 may be embodied using any currently known media such as magnetic or optical storage media including removable media such as floppy disks, compact discs, etc. Regardless, the storage device 306 has stored thereon instructions that may be executed by the one or more processors 304 such that the processor(s) 304 implement the functionality described herein. As known in the art, however, some or all of the software-implemented functionality may be implemented using firmware and/or hardware devices such as application specific integrated circuits (ASICs), programmable logic arrays, state machines, etc.

As further shown, the one or more processors 304 may be in communication with various user input/output devices 308 that allow a user of the processing apparatus 302 to interact therewith. For example, the user input/output devices 308 may comprise one or more display screens, keyboards, user selection devices (e.g., a mouse and cursor combination, a touch screen, voice recognition interfaces, etc.), speakers, microphones, etc. The one or more processors 304 may also be in communication with other interfaces 310 that provide one or more communication interfaces between the processing apparatus 302 and external devices, such as the network 204 and/or the servers 206-208 illustrated in FIG. 2. The nature of the other interfaces 310 necessarily depends on the external devices that the processing apparatus 302 communicates with. For example, where the processing apparatus 302 is coupled to a network (such as network 204) via a wired connection, the interfaces 310 may comprise the software, firmware and/or hardware necessary to terminate the relevant network protocols. Similarly, where the processing apparatus 302 communicates with a wireless network, the interfaces 310 may comprise the components needed to terminate the wireless protocol. Once again, those having skill in the art will appreciate that various implementations are possible, and that the present invention is not limited in this regard.

As known in the art, the storage devices 306 comprise executable instructions that may be used to implement in analysis spreadsheet 312 as well as one or more data access interface programs 314. In an embodiment, the analysis spreadsheet 312 may be implemented using a known spreadsheet application such as the Microsoft Excel spreadsheet program. In a similar vein, the data access interfaces 314 may be implemented using Business Objects' Desktop Intelligence client or Business Objects' Universe Designer client. The data access interface programs 314 may also comprise customized data mining software capable, using known programming techniques, of directly analyzing the data objects. Further still, such customized data mining software can cooperate with application programming interfaces (APIs) of the commercial clients (e.g., Desktop Intelligence or Universe Designer) for the same purpose. In combination, the analysis spreadsheet 312 and the data access interface(s) 314 implement that functionality of the complexity analyzer 102 used to determine the complexity of one or more data object parameters corresponding to a data object. In particular, the data access interface(s) 314 can access the targeted data objects and obtain the desired data object parameter values. In turn, the analysis spreadsheet 312 operates upon values obtained by the data access interface 314 from the data objects. To the extent that the data objects are stored remotely relative to the processing apparatus 302, the data access interface(s) 314 accesses the data objects via one of the other interfaces 310 implemented within the processing apparatus 302. In an alternative embodiment, the desired data objects may be stored in the storage device(s) 306 thereby allowing direct analysis by either the analysis spreadsheet 312 or the data access interface 314.

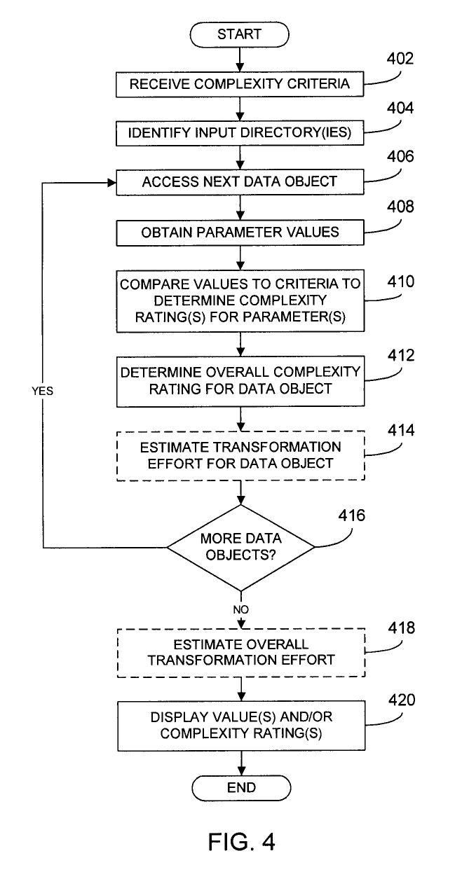

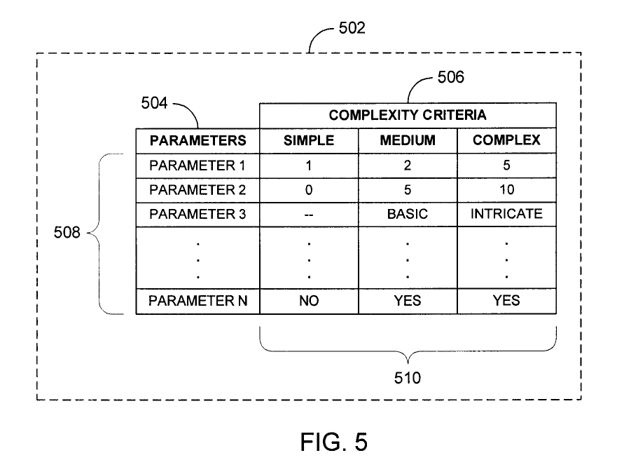

Referring now to FIG. 4, processing in accordance with various embodiments is further illustrated in flowchart form. In an embodiment, the processing illustrated in FIG. 4 is implemented by the processing apparatus 302, unless noted otherwise. Thus, beginning of block 402, complexity criteria is received via a user interface. Complexity criteria, as used in herein, comprises various values that may be used to assess the relative complexity of a given data object parameter value. An example of this in the context of a suitable user interface is further illustrated with respect to FIG. 5.

As shown in FIG. 5, a portion of a graphical user interface 502 (e.g., graphical elements displayed on a suitable display screen) is illustrated comprising a parameters column 504 and associated complexity criteria columns 506. As shown, N different parameters 508 are illustrated within the parameters column 504 and, within each of the various complexity criteria columns 506, a plurality of complexity criteria values 510, corresponding to the various data object parameters 508, are shown. In an embodiment, the various data object parameters 508 are pre-defined (i.e., not user configurable) based on the types of data object to be analyzed. In contrast, the complexity criteria values 510 are user configurable, with the specific values being chosen so as to clearly define the conditions necessary for a given data object parameter to be rated any one of a variety of complexity ratings.

Illustrative examples of this are shown in FIG. 5. Note that, as shown, three separate complexity ratings are available for each parameter: “simple”, “medium” and “complex”. Those of ordinary skill in the art will appreciate, however, that a greater or lesser number of complexity ratings may be provided as a matter of design choice. In the illustrated example, a first parameter (parameter 1) has a complexity criteria value of 1 corresponding to the “simple” rating, whereas complexity criteria values of 2 and 5 are respectively associated with the “medium” and “complex” ratings. Likewise, a second parameter (parameter 2) has values of 0, 5 and 10 respectively associated with the “simple”, “medium” and “complex” ratings. Note that the criteria values aren't restricted to numerical values and may comprise textural indicators as illustrated with regard to third and N'th parameters (parameters 3 and N) in which textual values, such as “basic” and “intricate”, or binary values such as “no” and “yes”, may be equally employed. In this manner, the complexity criteria values 510 essentially establish thresholds that may be used to determine the relative complexity of various parameters within a data object. Note that the association of data object parameters 508 to the corresponding complexity criteria values 510 illustrated in FIG. 5 reflect the association of corresponding parameter fields and complexity criteria fields that may be used as part of a data structure, stored in a suitable machine readable medium (such as storage devices 306), which data structure may be accessed when storing and/or use the complexity criteria in accordance with the processing of FIG. 4.

Referring once again to FIG. 4, processing continues at block 404 where one or more input directories are identified via the graphical user interface. The one or more directories specified in block 404 are addresses of the respective storage devices comprising the one or more data objects to be analyzed in accordance with the illustrated method. Techniques for specifying such directories via a graphical user interface (e.g., through the use of a suitable interface control such as data entry box or pull-down menu) are well known to those having ordinary skill in the art. As noted above, the identified input directory(ies) may comprise local or remote storage relative to the processing apparatus implementing the processing of FIG. 4.

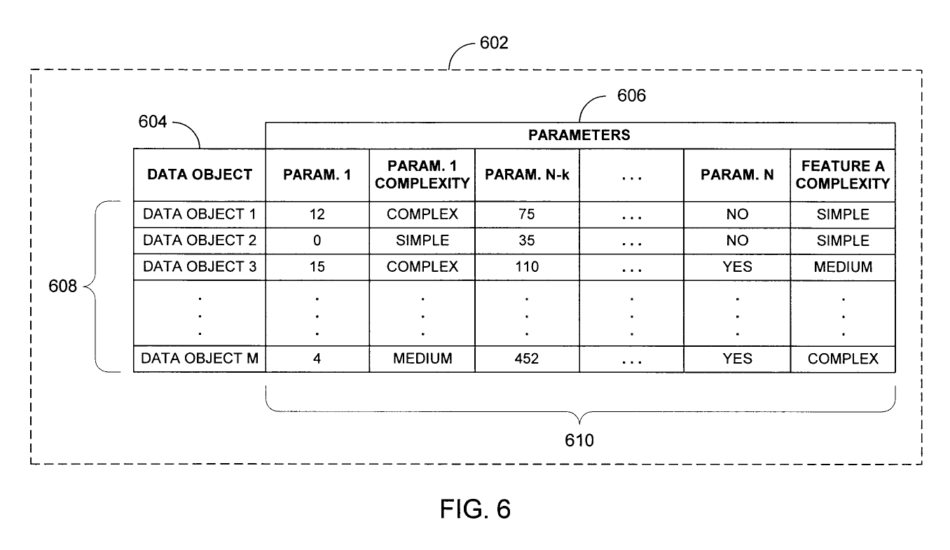

Thereafter, processing continues at block 406 where a data object to be analyzed is accessed. In an embodiment, only those data objects having predetermined file extensions, as known in the art, are accessed at block 406. For example, and with further reference to FIG. 3, any of the data access interfaces 314 may be used to access either reports (.rep) or universes (.unv) as desired. At block 408, values for one or more of the data object parameters are obtained. For example, and once again with reference to FIG. 3, the data access interface(s) 314 may obtain the desired values through inspection of metadata associated with the data object. In the case of Business Objects' Desktop Intelligence and/or Universe Designer clients, built in APIs allow access to the desired metadata. Alternatively, as noted above, the APIs may be used in conjunction with customized data mining software that can directly analyze a data object to ascertain the desired data object parameter values, e.g., counting the number of occurrences of a given item within the data object. Other techniques for ascertaining parameter values may be apparent to those of skill in the art. Thereafter, at block 410, processing continues where the data object parameter values obtained at block 408 are compared to various ones of the complexity criteria defined at block 402. In this manner, complexity ratings (e.g., “simple”, “medium” or “complex”) can be determined for each of the corresponding data object parameters. Various examples of this are further illustrated in FIG. 6.

Referring now to FIG. 6, a portion of a graphical user interface 602 is illustrated in which a data object column 604 and one or more parameter columns 606 are illustrated. Underneath the data object column 604, a variety of data objects 608 (M shown) are listed. Within the parameter columns 606, the values 610 for each data object parameter and the complexity parameter ratings corresponding to each data object are illustrated. For example, with respect to parameter one (“Param. 1”) illustrated in FIG. 6, various parameter values and resulting complexity ratings are shown for each of the M different data objects. In an alternative embodiment, multiple data object parameters may be assessed when determining the complexity rating not just of a single parameter, but of a larger characteristic or feature based on the data object parameter values for multiple data object parameters. This is illustrated in FIG. 6 where up to K parameters (“Param. N-K” through “Param. N”) are shown contributing to the complexity rating for feature “A”. In this manner, especially important parameters may receive their own complexity rating, whereas parameters of lesser importance or parameters that are best assessed collectively, may also receive corresponding complexity ratings.

Referring once again to FIG. 4, processing continues at block 412 where an overall complexity rating for the data object may be determined based on the one or more complexity parameter ratings determined at block 410. For example, the overall complexity of a given data object may be based on the various complexity parameter ratings determined for that data object that may be combined in any desired fashion to come up with the single overall complexity rating. For example, in one embodiment, the overall classification rating is determined by the “highest” complexity parameter rating for the data object. That is, is one or more of the data object parameters is rated “complex”, then the overall complexity rating for the data object is also “complex”, and so on. In another embodiment, if each complexity rating is assigned a numerical value (e.g., “simple”=1, “medium”=2, “complex”=3), the overall complexity rating for the data object may be determined as a simple average of all of the complexity ratings determined for the various data object parameters for that data object.

Referring once again to FIG. 4, processing optionally continues at block 414 where an estimated effort for transforming the data object is determined based on the at least one complexity parameter rating (or the overall complexity rating). For example, historical data concerning the necessary effort to achieve the desired transformations (for each of the complexity ratings, e.g., “simple”, “medium” and “complex”) may be used to forecast the required effort for the currently targeted data objects. Typically, such efforts are expressed in units of time, e.g., hours. In this case, cost estimates may also be generated by multiplying the estimated time by an appropriate cost rate, e.g., an average per hour consulting rate. The estimated effort for transforming the data object may be expressed in any suitable units such as, but not limited to: measures of analyst time in hours, days, weeks, months or years; measures of monetary cost; measures of computing or other resource usage, etc. Further still, the estimated effort may be described as a combination of such units as a matter of design choice.

Regardless whether the processing of block 414 is performed, once the various complexity ratings have been determined for the desired data object parameters and/or the data object itself, processing continues at block 416 where it is determined whether more objects are available to be analyzed. If so, processing continues at block 406, as described above, where the next available data object is accessed. This process continues until all available data objects meeting the desired selection criteria (e.g., designated file extensions) have been accessed and analyzed as described above with reference to blocks 408-414. If additional data objects are not available block 416, i.e., the input directory(ies) has been completely processed, processing optionally continues at block 418 where an overall estimated effort for transforming all of the analyzed data objects may be determined. For example, in a relatively simple embodiment, the efforts for transforming the individual data objects may be simply summed together to come up with the overall estimated effort. Those who have an ordinary skill in the art will appreciate that more complex transformation techniques may be equally employed as a matter of design choice.

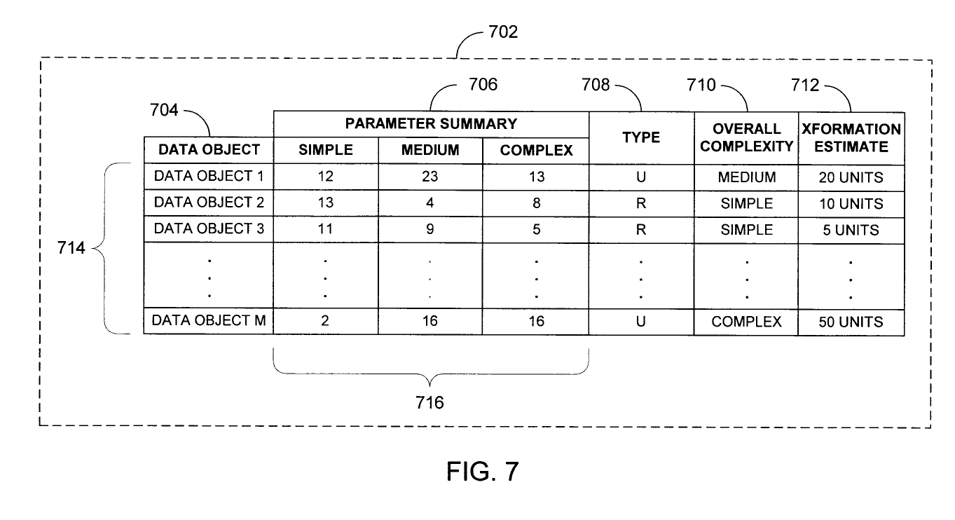

Finally, at block 420, the previously determined values and/or complexity ratings are preferably displayed via the user interface. This is illustrated in FIGS. 6 and 7. As described above, FIG. 6 illustrates the various data object parameter values and resulting complexity parameter ratings 610 for each data object 608. In contrast, FIG. 7 illustrates a portion of a graphical user interface 702 in which a data object column 704 and corresponding parameter summary columns 706, a type column 708, an overall complexity column 710 and a transformation estimate column 712 are illustrated. In essence, the display 702 provides a summary of the complexity analysis of each data object. To this end, across each of the columns 706-712 and for each of the M different data objects 714, a corresponding value 716 or rating is provided. Thus, the parameter summary columns 706 display the totals of how many of the data object parameters were assigned the indicated complexity rating. For example, “Data Object 1” had 12 parameters assigned a “simple” complexity rating; 23 parameters assigned a “medium” complexity rating; and 13 parameters assigned a “complex” complexity rating. The type column 708 displays a type indicator (e.g., “U” for a universe or “R” for a report) for the corresponding data object. The overall complexity column 710 sets forth the overall complexity rating, as noted above, for the corresponding data object. Finally, the transformation estimate column 712 provides the estimated effort (illustrated with generic “units” in FIG. 7) to perform the desired transformation of the corresponding data object.

As described above, the instant disclosure describes various techniques for quickly and accurately assessing the complexity of data objects. This is achieved through the provision of complexity criteria via a user interface, which complexity criteria can be used to quickly assess the relative complexity of various data object parameters for each data object under consideration. For at least these reasons, the above-described techniques represent an advancement over prior art teachings.

While particular embodiments have been shown and described, it will be obvious to those skilled in the art that changes and modifications may be made without departing from the instant teachings. It is therefore contemplated that any and all modifications, variations or equivalents of the above-described teachings fall within the scope of the basic underlying principles disclosed above and claimed herein.

What is claimed is:

1. In a processing apparatus, a method for estimating complexity of a data object, the method comprising:
receiving, via a user interface of the processing apparatus, complexity criteria for a plurality of data object parameters;
analyzing, by the processing apparatus, the data object to obtain values corresponding to at least one data object parameter of the plurality of data object parameters; and
comparing, by the processing apparatus, the values with that portion of the complexity criteria corresponding to the at least one data object parameter to determine at least one complexity parameter rating corresponding the at least one data object parameter.

2. The method of claim 1, further comprising:
determining, by the processing apparatus, an overall complexity rating for the data object based on the at least one complexity parameter rating.

3. The method of claim 1, further comprising:
determining, by the processing apparatus based on the at least one complexity parameter rating, an estimated effort for transforming the data object.

4. The method of claim 1, wherein the data object is either a Universe or a Report.

5. The method of claim 1, further comprising:
displaying, via the user interface, at least one of: the values corresponding to the at least one data object parameter and the at least one complexity parameter rating corresponding to the at least one data object parameter.

6. The method of claim 1, further comprising analyzing the data object via a client application, implemented by the processing apparatus, that communicates with at least one storage element comprising the data object.

7. A processing apparatus, comprising:
at least one processor;
a user interface in communication with the at least one processing device; and
at least one storage component in communication with the at least one processing device and having stored thereon executable instructions that, when executed by the at least one processor, cause the at least one processor to:
receive, via the user interface, complexity criteria for a plurality of data object parameters;
analyze a data object to obtain values corresponding to at least one data object parameter of the plurality of data object parameters; and
compare the values with that portion of the complexity criteria corresponding to the at least one data object parameter to determine at least one complexity parameter rating corresponding the at least one data object parameter.

8. The apparatus of claim 7, the at least one storage component further comprising executable instructions that, when executed by the at least one processor, cause the at least one processor to:
determine an overall complexity rating for the data object based on the at least one complexity parameter rating.

9. The apparatus of claim 7, the at least one storage component further comprising executable instructions that, when executed by the at least one processor, cause the at least one processor to:
determine, based on the at least one complexity parameter rating, an estimated effort for transforming the data object.

10. The apparatus of claim 7, the at least one storage component further comprising executable instructions that, when executed by the at least one processor, cause the at least one processor to:
display, via the user interface, at least one of: the values corresponding to the at least one data object parameter and the at least one complexity parameter rating corresponding to the at least one data object parameter.

11. The apparatus of claim 7, the at least one storage component further comprising executable instructions that, when executed by the at least one processor, cause the at least one processor to analyze the data object via a client application that communicates with a at least one storage element comprising the data object.

12. A processing system comprising:
at least one storage element comprising a plurality of data objects;
a user interface; and
a complexity analyzer, in communication with the at least one storage element and the user interface, operative to receive, via the user interface, complexity criteria for a plurality of data object parameters, analyze a data object of the plurality of data objects to obtain values corresponding to at least one data object parameter of the plurality of data object parameters, and to compare the values with that portion of the complexity criteria corresponding to the at least one data object parameter to determine at least one complexity parameter rating corresponding the at least one data object parameter.

13. The processing of system of claim 13, wherein the user interface and the complexity analyzer are implemented in a processing device.

14. The processing system of claim 13, wherein the at least one storage element comprises any of: a server computer and the processing device.

15. The processing system of claim 13, wherein the processing device communicates with the at least one storage element via at least one communication network.

16. The processing system of claim 12, wherein the complexity analyzer is further operative to determine an overall complexity rating for the data object based on the at least one complexity parameter rating.

17. The processing system of claim 12, wherein the complexity analyzer is further operative to determine, based on the at least one complexity parameter rating, an estimated effort for transforming the data object.

18. The processing system of claim 12, wherein the complexity analyzer is further operative to display, via the user interface, at least one of: the values corresponding to the at least one data object parameter and the at least one complexity parameter rating corresponding to the at least one data object parameter.

19. A processor readable medium having stored thereon a data structure comprising:
a plurality of parameter fields each identifying a corresponding one of a plurality of data object parameters relevant to a data object; and
corresponding to each of the plurality of parameter fields, at least one complexity criteria field comprising at least one complexity criteria value that, during analysis of the data object, are compared to values for the data object corresponding to at least one data object parameter of the plurality of data object parameters to determine at least one complexity parameter rating corresponding the at least one data object parameter.

20. The processor readable medium of claim 19, where the at least one complexity criteria field for each of the plurality of parameter fields comprises a simple complexity field, a medium complexity field and a complex complexity field.

21. In a processing apparatus, a method for estimating complexity of transformation of a plurality of data objects, the method comprising:
receiving, via a graphical user interface of the processing apparatus, complexity criteria for a plurality of data object parameters;
analyzing, by the processing apparatus, each data object of the plurality of data objects to obtain corresponding values for at least one data object parameter of the plurality of data object parameters;
comparing, by the processing apparatus for each data object of the plurality of data objects, the corresponding values with that portion of the complexity criteria corresponding to the at least one data object parameter to determine, for each data object, at least one complexity parameter rating corresponding the at least one data object parameter;
determining, by the processing apparatus for each data object of the plurality of data objects, an overall complexity rating based on the at least one complexity parameter rating for the data object; and
determining, by the processing apparatus, an overall estimated effort for transforming the plurality of data objects based at least in part upon overall complexity rating for each data object of the plurality of data objects.

22. The method of claim 21, further comprising:
displaying, via the graphical user interface, at least one of: the corresponding values for each data object of the plurality of data objects and the at least one complexity parameter rating for each data object of the plurality of data objects.

23. The method of claim 21, further comprising:
displaying, via the graphical user interface, the overall complexity rating for each data object of the plurality of data objects.

24. The method of claim 21, further comprising:
determining, by the processing apparatus for each data object of the plurality of data objects, an estimated effort from transforming the data object based on the at least one complexity parameter rating for the data object; and
displaying, via the graphical user interface, the estimated effort for transforming each data object of the plurality of data objects.

25. The method of claim 1, wherein each data object of the plurality of data objects is either a universe or a report.
